(19) United States
(12) Patent Application Publication
(10) Pub. No.: US 2018/0163434 A1
(43) Pub. Date: Jun. 14, 2018

(54) PROGRAMMABLE LOCK WITH PULL PIN ASSEMBLY

(71) Applicant: HORIZON GLOBAL AMERICAS INC., Plymouth, MI (US)

(72) Inventor: Matthew O. Weller, South Lyon, MI (US)

(21) Appl. No.: 15/839,968

(22) Filed: Dec. 13, 2017

Related U.S. Application Data
(60) Provisional application No. 62/434,096, filed on Dec. 14, 2016.

(51) Int. Cl. E05B 73/00; B60D 1/60; F16B 21/09; F16B 21/12

(52) U.S. Cl. CPC E05B 73/00; F16B 21/125; F16B 21/09; B60D 1/605

(57) ABSTRACT

A sliding housing cooperates with various mechanisms designed to receive a programmable locking cylinder. Rotation of the key between locked and unlocked positions also urges protrusions associated with the locking cylinder into engagement with an annular groove in a pull pin to selectively fix the locking assembly to the pin.

This application claims priority to U.S. Provisional Patent Application 62/434,096 filed on Dec. 14, 2016, which is incorporated by reference herein.

The present invention relates generally to a locking assembly for use in connection with towing accessories and, more specifically, to a pull pin having a lock capable of cooperating with a range of different physical keys.

### BACKGROUND

### Technical Field

Many towing accessories are attached through the use of a standard pull pin. Typically, the pull pin is inserted through a plurality of apertures formed in both the attachment mechanism of the vehicle (e.g., a hitch) and the accessory cooperating with that mechanism (e.g., a tow bar, cargo carrying apparatus, bicycle rack, etc.). These pins tend to have standardized diameter (e.g., ½ inch, ⅝ inch, etc.) and may include a grasping mechanism on one end and securing mechanism on the other end. The grasping mechanism may be as simple as slight bend, and/or could include a flange, grasping loop, or the like. The securing mechanism can be an R-shaped or hairpin clip or any number of variations of a cotter pin or split pin. While pins are easy to secure, they are also susceptible to unwanted removal, which could lead to theft, loss, and/or failure of the towing accessory.

In order to guard against such unwanted removal, some pull pins 10 are provided with a locking assembly fitting over one end, as shown in FIG. 1. The grasping end 20 includes a bent portion 22. The locking end 30 includes a lockable cylinder 32 removably affixed its end. Key 34 is inserted and turned to release the cylinder 32 from the pin 10, thereby allowing the user to selectively remove the pin from a device. A cover 36 may be provided for aesthetics and/or to prevent water ingress into the cylinder 32. Typically, the locking cylinder has one or more engagement mechanisms (not visible) which cooperate with one or more grooves, indents or apertures in the locking end 30 of the pin 10 to allow the cylinder 32 to remain in place. Thus, when the cylinder is engaged and affixed to a pin that is inserted through a receiver hitch and towing apparatus (as one example), the locking cylinder prevents the pin from being removed.

In some prior art embodiments, a spring is positioned proximate to the locking assembly. In function, the spring is configured to automatically urge one or more tabs into a locked position when the cylinder is depressed. Conversely, when the key is inserted and turned, the tabs disengage, and the cylinder 32 “pops off” the locking end 30 (i.e., along the longitudinal axis of the pin 10).

One shortcoming of this arrangement is that the use of a locking cylinder requires its own key. Also, the presence of a spring automatically urges the tabs into a locked position irrespective of whether the key is turned to lock the assembly, thereby leading to the possibility of accidentally locking the pin in place when the user does not have the key to unlock it.

### SUMMARY

The present system relies upon a programmable locking cylinder. This cylinder enables the use of a single key (e.g., an ordinary house key, etc.) to use in conjunction with a locking pull pin. In some aspects, the assembly includes a programmable lock cylinder having a slot at one end which receives and conforms to an appropriately sized key. The cylinder is coaxially fitted within an engagement sleeve. In turn, the engagement sleeve has spheres or protrusions that selectively cooperate with a groove on the surface of the pull pin to affix the assembly to the pin. Alternatively, a tab situated at the non-keyed end of the cylinder/sleeve rotates into a locked positions. In certain aspects, a spring mechanism facilitates removal of the assembly from the pin.

One exemplary aspect of the invention may include any combination of the following features:
a locking cylinder disposed within an distal of an exterior housing;
an end cap having an aperture positioned within the exterior housing at an opposed, proximal end;
a rotating assembly having projections which move selectively in response to rotation of a key within the locking cylinder;
wherein the projections engage an object inserted through the aperture;
wherein the object is a pull pin having a circumferential groove to securely receive the projections when the assembly is locked;
wherein the rotating assembly includes a rotating tab;
wherein the rotating tab moves along a defined arc to selectively engage a slot formed in a slide housing positioned within the exterior housing between the locking cylinder and the end cap;
wherein at least one restrictor element defines the defined arc;
wherein the restrictor element includes a cam or a channel;
a ramp positioned proximate to the slide housing, said ramp facilitating the movements of the projections;
wherein the locking cylinder is a programmable locking assembly.
wherein the rotating assembly includes a threaded connector which engages a sliding cap, said connector and sliding cap positioned within the exterior housing between the locking cylinder and the end cap; and
wherein the sliding cap includes at least one slide projection moving within an axial slot formed in a slide housing positioned proximate to the sliding cap.

Specific reference is made to the appended claims, drawings, and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DESCRIPTION OF THE DRAWINGS

Operation of the invention may be better understood by reference to the detailed description taken in connection with the following illustrations. These appended drawings form part of this specification, and any written information in the drawings should be treated as part of this disclosure. In the same manner, the relative positioning and relationship of the components as shown in these drawings, as well as their function, shape, dimensions, and appearance, may all further inform certain aspects of the invention as if fully rewritten herein. In the drawings:

FIG. 1 is a three dimensional perspective view a lockable pull pin according to the prior art.

FIG. 2A is an exploded side view of the components in a first aspect of the invention.

FIGS. 2C is a bottom view of the assembly shown in FIG. 2A (viewed along axial line A in FIG. 2D) in its locked position, while FIG. 2B is a partially transparent, three dimensional sectional view of the assembly shown in FIG. 2A in its locked position.

FIGS. 2F is a bottom view of the assembly shown in FIG. 2A (viewed along axial line B in FIG. 2G) in its unlocked position, while FIG. 2E is a partially transparent, three dimensional sectional view of the assembly shown in FIG. 2A in its unlocked position.

FIG. 3A is an exploded side view of the components in a second aspect of the invention.

FIGS. 3B and 3C are partially transparent, three dimensional sectional views of the assembly shown in FIG. 3A in its locked position.

FIGS. 3D and 3E are partially transparent, three dimensional sectional views of the assembly shown in FIG. 3A in its unlocked position.

FIG. 4 is a three dimensional perspective view of the sliding assembly used in the second aspect.

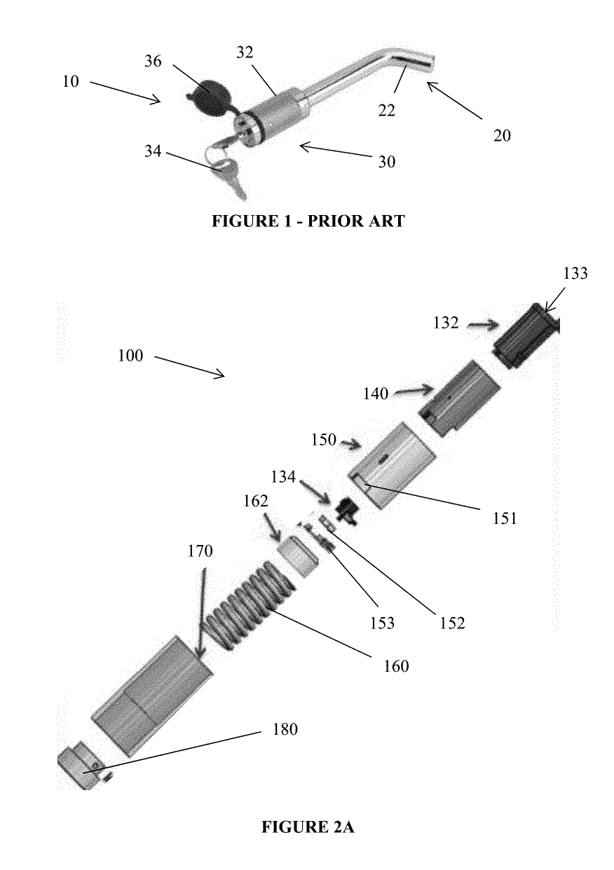

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

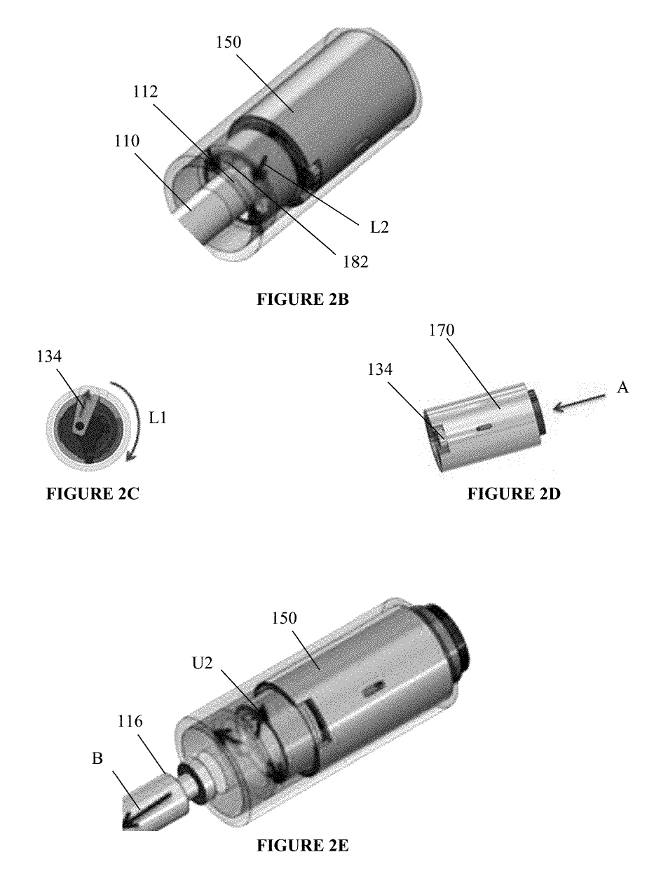

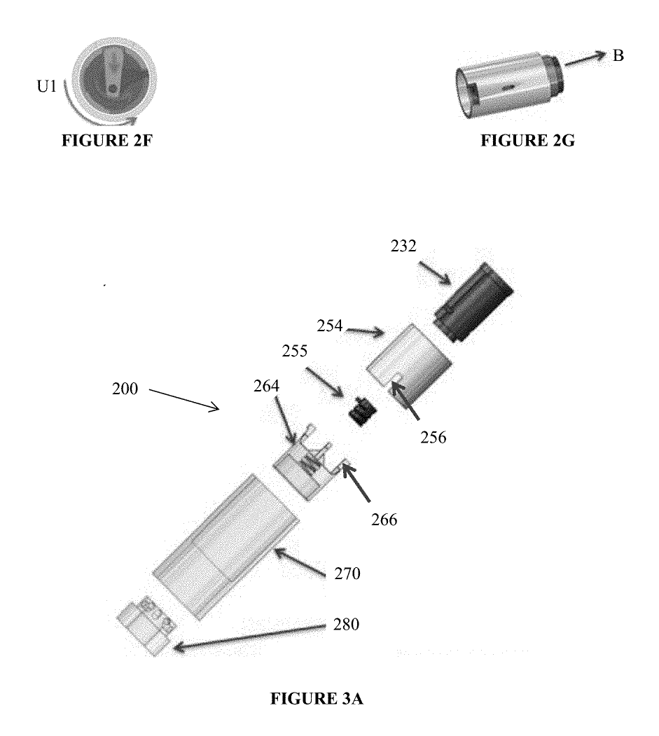

One embodiment of lockable pull pin assembly 100 is shown in exploded view in FIGS. 2A, as well as a variety of other perspectives for the locked (in FIGS. 2B, 2C, and 2D, with line A indicating the direction the assembly moves to lock) and unlocked (in FIGS. 2E, 2F, and 2G, with line B indicating the direction the assembly moves to unlock) positions. Assembly 100 includes an locking cylinder 132, engagement sleeve 140, and lock housing 150. Cylinder 132 is coaxially fitted within at least a portion of sleeve 140, while sleeve 140 is encased by the lock housing 150.

Cylinder 132 includes a key slot (not visible) at its exposed, distal end 133. Generally speaking, the cylinder 132 includes a plurality of racks and pins that cooperate with a locking bar to enable the cylinder to “learn” the contour presented by a typical single or double sided pin tumbler-style lock key. Programmable lock cylinders appropriate for use with certain aspects of the invention disclosed or contemplated herein can be found, inter alia, in United States Patent Publications 2012/0312127 and 2013/0086957 and U.S. Pat. No. 7,634,930; 7,900,491; and 7,047,778. The disclosure of these documents, including the description and drawings, are all incorporate by reference as if fully rewritten herein.

A rotating tab 134 moves in concert with a key when the key is properly fitted and, therefore, capable of turning within cylinder 132. When the locking action of cylinder 132 is engaged (i.e., locked), the tab 134 extends through a sidewall slot 151 of the housing 150. The slot 151 is on or proximate to the proximal end of the assembly (i.e., opposed to distal end 133). Arrow L1 indicates a direction in which the tab 134 may be rotated to toggle move between the locked and unlocked positions.

A spring 160 is positioned at the proximal end (i.e., facing the pull pin 110) between the assembly end cap 180 and plunger 162. Plunger 162 cooperates with spring 160 within the slide housing 170 to exert outward force. As such, the spring 160 urges the cylinder 132 outward (toward the distal end 133 and away from pin 110) unless the cylinder 132 is in a locked position. Pin 110 is received through an appropriate aperture in end cap 180.

In operation, the user also depresses the cylinder along line A as shown in FIG. 2D. In this manner, the tab 134 may be aligned so that it may be rotated into the slot 151. When rotated into slot 151, the lock housing 150, sleeve 140, and cylinder 132 are all restricted from any further axial movement (e.g., along line A). In effect, this causes housing 150 and its associated parts (e.g., tab 134, sleeve 140, etc.) to be locked in place.

Also, the downward axial force (i.e., along line A as shown in FIG. 2D) urges spheroid projections 182 inward along lines L2 into an annular locking groove 112 formed on the pin 110. The projections preferably include rounded ends to slide, if needed, within or along a portion of the inner facing of housing 170 in an axial direction and they have sufficient spring-like flexibility to permit movement in the radial direction. For example, a plurality of projections are formed at even spaces around the periphery of the end cap 180. These projections extend inward and, optionally, axially from the cap, although, however many projections are used, the projections correspond to the appropriate orientation of the groove. Preferably, the groove and projections are formed in a single, orthogonal plane.

As the spring 160 is compressed by the terminal end 114 of pin 110 and the inward force exerted at the distal end 133 of the assembly 100, the projections 182 are urged inwardly by a cone or corresponding ramps formed on a proximal, inner surface of a corresponding part of the assembly 100 that does not move relative to the projections 182 (e.g., an inner surface of the slide housing 170, etc.). Thus, depressing and locking the cylinder 132 in place (as described above) also serves to urge the projections 182 within the groove 112 and retain the two in place when the assembly 100 is locked.

In contrast, when the assembly is unlocked, the tab 134 is rotated along line U1 and retracts out of the slot 151. Thus, the sleeve 140 is movable relative to the slide housing 170 (because the tab 134 is not lodged within the slot 151). When unlocked, the spring 160 urges the housing 150 and its associated parts away from the pin 110 along line B and toward the distal end 133. The projections are released radially outward from the groove 112 along line U2, so that the assembly 100 can ultimately be removed from the end of the pin 110. With the locking assembly 100 thus removed, the pin 110 itself can be decoupled from the hitch and/or vehicle accessory apparatus.

The opposing (i.e., non-locking) end of the pull pin may include a grasping mechanism in addition to a bent portion, such as a handle, a loop, or the like. Also, the pin 110 may include a flange or stopping step 116 having an increased diameter in comparison to the terminal end 114. This stop step 116 cooperates with a flange or similar stop on assembly 100 (e.g., on the end cap 180 and/or slide housing 170) to ensure the assembly is not overly compressed during the locking and unlocking operations.

Any of end cap 180, slide housing 170, plunger 162, and/or lock housing 150 may include flanges, tabs cooperating within grooves, stops, or other mechanisms to limit the axial distance these components move within the slide housing 170 relative to one another. In the same manner, the cylinder 132 may be affixed or fastened to the sleeve 140 to allow for installation of the cylinder 132 while still ensuring proper operation and locking of the assembly 100. The aforementioned components may be formed from any appropriate metal or polymer, with exterior facing components (e.g., slide housing 170) given appropriate aesthetic consideration. Fasteners and adhesives may be employed in making necessary connections.

A series of connector pieces can be associated with the proximate end of cylinder 132, sleeve 140, and/or lock housing 150. As shown in FIG. 2A, restrictor elements 152 and 153 cooperate with the rotation of tab 134 to restrict its rotational range of motion. In one aspect, elements 152, 153 define an arc through which the tab 134 may rotate. These pieces also provide sufficient spacing and contact between the plunger 162 and the rotating components involved with the locking procedure. Additionally or alternatively, piece 152 may act in concert with the tab 134 to ensure it moves in an effectively radial direction, rather than rotating, possibly by way of a cam or a channel and tab configuration. Other, similar orientations are possible, so long as the tab 134 is controllably inserted and removed from the slot 151 in combination with the rotation of the key.

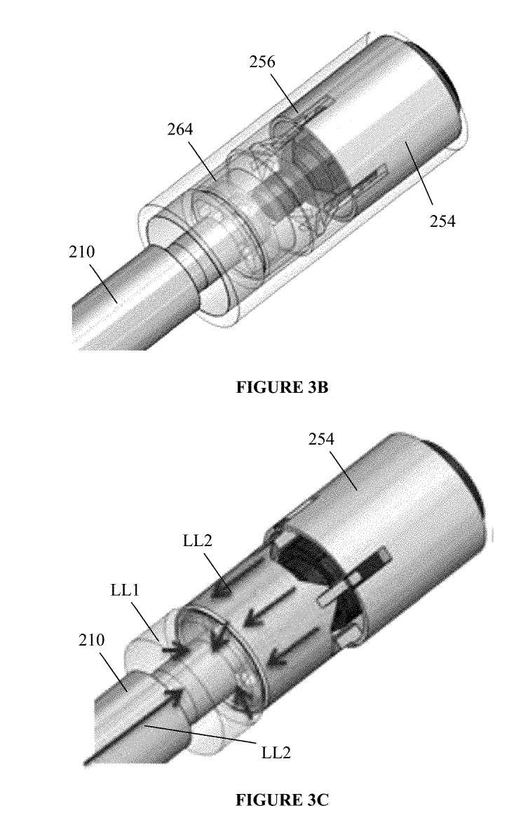

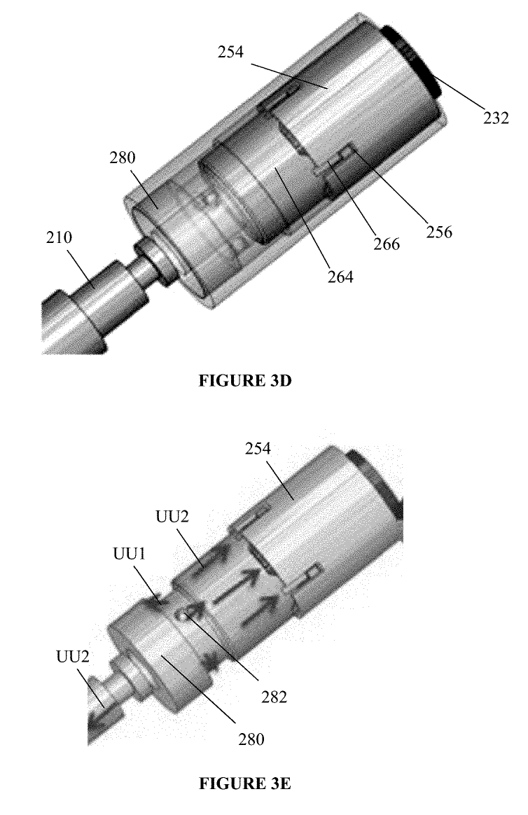

An alternative arrangement for a lockable pull pin assembly 200 is illustrated in FIGS. 3A through 3E. Unless otherwise noted, parts having similar ending digits described for assembly 100 can be applied to assembly 200 and vice versa. Unless noted below, the principles of operation are also similar to assembly 100.

In assembly 200, a threaded sliding cap 254 fits coaxially around locking cylinder 232, which includes distal end 233 with a programmable key slot (not shown) as above. Threaded connector 255 is fitted at the end of cap 254 that is opposite the key slot, which is exposed on the distal end of the assembly 200 (i.e., opposite end cap 280). Connector 255 also cooperates to receive portions of sliding assembly 264, as will be described in greater detail below. Slide housing 270 fits around the exterior the cap 254 and also contains end cap 280 at the proximal end where the pin 210 is received. End cap 280 has a central annular aperture which receives the terminal end of pin 210 so that annular grooves 212 may be engaged with the protrusions 282 associated with the sliding assembly 264.

Longitudinal slots 256 in the cap 254 cooperate with guide members 266 on the sliding assembly 264 to guide the axial motion of the components while preventing unwanted rotation of cap 254 relative to cylinder 232. The rotational movement of the cylinder 232 serves to mate the connector 255 with the assembly 264, with threads are provided in cooperating male and female orientations on the assembly 264 and the connector 255 to facilitate in this regard. As before, elements can be provided to limit the rotational movement of the cylinder 232 within a defined arc. Lines LL1, LL2 indicate relative movements during the locking sequence (similar to assembly 100), while lines UU1, UU2 show the corresponding unlocking motions.

On the opposing side of assembly 264, spherical protrusions 282 cooperate with a cone shaped, distally facing end of annular cap 280 to urge the protrusions into the groove 212 and, thereby, lock the assembly 200 in place when rotational locking force is applied to the cylinder 232. When the key is rotated in an unlocking fashion, the threads create axial separation to urge the protrusions 282 radially out from the groove 212. The axial movement facilitates by the cooperation of threaded connector 255, assembly 264, and cylinder 232.

As above, this unlocked position enables the user to remove the locking assembly 200 from the end of pin 210 for its intended use. Also as above, this arrangement enable the use of a programmable locking cylinder 232. The various moving and non-moving parts can be assembled using the same approaches described for assembly 100.

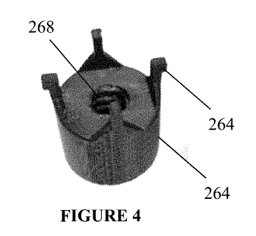

FIG. 4 shows an arrangement of four guide members 266 along the distal-facing side of the sliding assembly 264. Any number of these members 266 can be provided, so long as they correspond with an appropriate number of slots 256. The terminal end of members 266 may include a snap-fit with the end of the slots 256. A female threaded connection 268 is shown in a central location of assembly 264, although a male connection could be used and/or the positioning of the threaded connectors need not be centralized (although centralized members simplifies alignment and fabrication of assembly 200). A cooperating fitting on connector 255 engages connection 268, with theards, channels, or other structure facilitating the rotational movement. Although not visible in FIG. 4, projections 282 may be formed on the opposing side of assembly 264 (i.e., the underside in this view) according to the same guidance as described for assembly 100 above.

The arrangements described, disclosed, and shown herein readily accommodate the use of any number of a programmable locking cylinders. Such cylinders may be purchased from a variety of manufacturers, including the Kwikset Corporation of Lake Forest, Calif., USA and Strattec Security Corporation of Milwaukee, Wis., USA. The use of a plurality of protrusions allows for a secure and evenly distributed fit along opposing and/or spaced apart points within the annular groove of the pin (as opposed to establishing a single forced fit connection if, for example, a simple rotating tab engaged the groove). In the same manner, this arrangement avoid the need to align the assembly in any particular orientation relative to the pin, thereby providing an easy-to-use assembly and especially in installations where limited space restricts the user's ability to rotate or reposition the bent portion of the pull pin.

All of the aspects of the invention described rely on turning the key to both lock and unlock the assembly. This arrangement protects the user against accidentally locking the pin when the key is not accessible. That is, in the case of assembly 100, after the cylinder 132 is depressed to align with the locking tab 134 and the slot 151, the key must be turned to move the tab 134 into the slot 151, while in the case of assembly 200, the longitudinal movement along the axis M is only accomplished by rotating the key to urge the male and female threaded portions together or apart. Further, the incorporation of a programmable locking cylinder permits users to use an existing key from some other application (e.g., a house key, a padlock key, etc.) to be used on the locking pin.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

What is claimed is:

1. A lockable assembly comprising:
a locking cylinder disposed within an distal of an exterior housing;
an end cap having an aperture positioned within the exterior housing at an opposed, proximal end; and
a rotating assembly having projections which move selectively in response to rotation of a key within the locking cylinder;
wherein the projections engage an object inserted through the aperture.

2. The assembly of claim 1 wherein the object is a pull pin having a circumferential groove to securely receive the projections when the assembly is locked.

3. The assembly of claim 1 wherein the rotating assembly includes a rotating tab.

4. The assembly of claim 3 wherein the rotating tab moves along a defined arc to selectively engage a slot formed in a slide housing positioned within the exterior housing between the locking cylinder and the end cap.

5. The assembly of claim 4 wherein at least one restrictor element defines the defined arc.

6. The assembly of claim 5 wherein the restrictor element includes a cam or a channel.

7. The assembly of claim 4 including a ramp positioned proximate to the slide housing, said ramp facilitating the movements of the projections.

8. The assembly according to claim 4 wherein the locking cylinder is a programmable locking assembly.

9. The assembly of claim 1 wherein the rotating assembly includes a threaded connector which engages a sliding cap, said connector and sliding cap positioned within the exterior housing between the locking cylinder and the end cap.

10. The assembly of claim 9 wherein the sliding cap includes at least one slide projection moving within an axial slot formed in a slide housing positioned proximate to the sliding cap.

11. The assembly of claim 10 wherein at least one restrictor element defines the defined arc.

12. The assembly of claim 11 wherein the restrictor element includes a cam or a channel.

13. The assembly of claim 10 including a ramp positioned proximate to the slide housing, said ramp facilitating the movements of the projections.

14. The assembly according to claim 10 wherein the locking cylinder is a programmable locking assembly.
